(19) United States
(12) Patent Application Publication
(10) Pub. No.: US 2008/0091620 A1
(43) Pub. Date: Apr. 17, 2008

(54) Method and computer program product for estimating the relative innovation impact of companies

(75) Inventors: Marc Vollenweider, Paternion (AT); Gaurav Batti, Gurgaon (IN); Animesh Kumar, Gurgaon (IN); Kushagra Sharma, Gurgaon (IN)

Correspondence Address: William L. Botjer, PO Box 478, Center Moriches, NY, 11934, US

(73) Assignee: Evalueserve.com Pvt. Ltd.

(21) Appl. No.: 10/773,548

(22) Filed: Feb. 6, 2004

(51) Int. Cl. G06Q 40/00

(52) U.S. Cl. 705/36 R

(57) ABSTRACT

A method for estimating the relative impact of two or more patent portfolios belonging to one or more companies is disclosed. Each patent of a patent portfolio is categorized into at least one market segment. A Technological Strength Index (TSI) is computed for each patent based on patent citations. An Economic Impact Index (EII) value is computed for each market segment based on the market size and market growth rate of the market segment, and the market share of the company in each market segment. A Company Innovation Efficiency Index (CIEI) value is computed for the patent portfolio based on the R&D expenditure of the company and the number of patents granted to the company. TSI and EII values of patents in a patent portfolio, and the CIEI value of the patent portfolio are used to compute an Overall Index for the patent portfolio. A similar exercise is carried out for all the portfolios being analyzed. The Overall Index provides a relative measure of the impact of the patent portfolios.

### FIELD OF THE INVENTION

The present invention relates to a quantitative estimation of the impact of the innovation practices of different companies, or the innovation practices of different units of a company. More specifically, the present invention provides a method and a computer program product to quantitatively estimate the impact of the innovation practices of different companies, or different units of the company, based on their patent portfolios.

### BACKGROUND

Innovation can be defined as the process of creating knowledge that may be of potential value to an organization, and then transforming such knowledge into potential products, processes and services. The practices aimed at creating knowledge, and then realizing potential value from this knowledge, will henceforth be called innovation practices.

Innovation practices can be broadly divided into two sub-practices—research practices and revenue-generation practices. The research practices of an organization define the organization's ability to come up with inventions in its field of operation. The revenue-generation practices of an organization define its ability to derive revenue from its innovations.

The products, processes and services of a company are the direct result of its innovation practices. These products, processes and services directly impact the technological and economic positioning of the company vis-a-vis its competitors. Therefore, it is imperative for companies to monitor their performance in terms of their innovation practices.

A company can monitor its performance either by internal benchmarking or by comparing its innovation practices with that of other companies or that of its competitors.

An important indicator of a company's performance in terms of innovation practices is its Intellectual Property (IP). IP rights empower a company to exclude its competitors from reproducing or using protected innovations without permission, and hence help in protecting the commercial interests of the company.

Patents constitute the primary form of IP used by technological companies to protect their innovations. A company can have a number of patents in the various technological fields of its operations. All patents that are assigned to a company taken collectively form a patent portfolio of that company, whereas, a subset of the patents forms a sub-folio. The patent portfolio can be used to assess the intellectual capital of a company. It is also an indicator of the level of innovation of the company. Further, a sub-folio of the company's patents in a technological domain can also be used to assess the intellectual capital in the technological domain.

For example, a company may compare its patent portfolio with that of its competitor in order to identify domains where it is relatively stronger or weaker than its competitor. In another case, a company may estimate the value of its portfolio by comparing it with another company's patent portfolio, which has already been evaluated. Further, a company may compare its patent portfolio with its competitor's portfolio in order to understand prospective areas of future research and development.

Conventional methods for comparing the patent portfolios of different companies involve the use of patent citations. Patent citations of a patent include the backward and forward references of the patent. The backward references of a patent are patents to which the patent refers, while the forward references are patents that cite the patent as a backward reference.

The number of backward references relating to a patent provides a measure of the maturity of the technology with which the patent is associated. A high number of backward references imply that significant growth has taken place in the technological field of the patent, and that it is not just a basic patent in its technological field. On the other hand, a lower number of backward references may imply that the patent is a basic patent in its technological field or, it may mean that the technology field is a new and emerging one.

Similarly, the number of forward references relating to a patent provides a measure of the innovation initiated by the patent in its field of technology. However, it should be noted that the number of forward references is a time-dependent variable. An older patent, owing to its longer period of existence in public domain, is likely to have a higher number of forward references than a relatively recent patent.

A number of different models, based on the use of patent citations, have been proposed for comparing different patent portfolios. One such patent is U.S. Pat. No. 6,556,992, titled ‘Method And System For Rating Patents And Other Intangible Assets’, assigned to Patent Ratings, LLC, Newport Beach, Calif. This patent provides a method of ranking patents on a regression model, using characteristics such as patent citations, the number of independent claims, length of the specification, and the age of cited references.

U.S. Pat. No. 6,263,314, titled ‘Method Of Performing Intellectual Property (IP) Audit Optionally Over Network Architecture’, assigned to Donner, provides a method for the valuation of an IP portfolio by assigning weights to patent indicators, such as the number of claims, length of the independent claims, and the number of patent citations.

U.S. Pat. No. 6,175,824, Titled ‘Method And Apparatus For Choosing A Stock Portfolio, Based On Patent Indicators’, assigned to Chi Research, provides a method for selecting companies in a stock market, based on the scores assigned to their patent portfolios.

The above-mentioned patents describe models that are based primarily on the use of patent citations to compare different patent portfolios. Since patent citations only reflect the technological strength of a patent, there is an inherent limitation associated with the use of such models. In other words, these models do not take into account the success of a company in generating revenue from its inventions, i.e., the company's revenue generation practices. Therefore, they do not provide a comprehensive measure of the overall impact of the innovation practices of the company.

Hence, there exists a need for a model that would provide a comprehensive estimate of the impact of the various innovation practices of a company. This model should also allow for estimating the impact of the company's innovation practices by taking into account not only the company's success in its research practices, but also in its revenue-generation practices.

### SUMMARY

An object of the present invention is to provide a method and a computer program product to estimate the relative impact of the one or more patent portfolios belonging to one or more companies.

Another object of the present invention is to provide a method for ranking a plurality of companies, based on their patent portfolios.

Yet another object of the present invention is to estimate the relative technology impact of a company's patent portfolio against that of its competitors.

A further object of the present invention is to estimate the economic impact of a company's patent portfolio against that of its competitors.

The present invention provides a method for estimating the relative impact of one or more patent portfolios belonging to one or more companies. The patent portfolio of each company comprises one or more patents. Each patent can belong to one or more market segments, which are impacted or can be potentially impacted by the patent.

In order to estimate the relative impact of the patent portfolio of a company, each patent of the patent portfolio is categorized into market segments. A Technological Strength Index (TSI) value is computed for each patent, based on the number of patent citations of the patent. Patent citations of a patent comprise the backward and forward references of the patent. Further, an Economic Impact Index (EII) value is computed for each patent. The EII value of the patent is computed based on at least one parameter from a set of parameters. These parameters include the market size, the market growth rate, and the market share of the company in each market segment to which the patent belongs. A Company Innovation Efficiency Index (CIEI) value is also computed for the patent portfolio, based on the Research and Development (R&D) expenditure of the company and the number of patents granted to the company over a period of time.

An Overall Index value is computed for the patent portfolio, using at least one parameter from a set of parameters. The parameters comprise the TSI and EII values of each patent in the patent portfolio, and the CIEI value of the patent portfolio. The Overall Index value of the patent portfolio provides a relative measure of the impact of the patent portfolio, when compared with another patent portfolio.

In an alternative embodiment of the present invention, the Overall Index value is used to rank companies. This ranking indicates the relative performance of companies in terms of their respective innovation practices.

The Overall Index value provides valuable information regarding a company's relative areas of strength vis-a-vis that of its competitors. This information is extremely useful in guiding the company's R&D and revenue generation practices related to IP and technology licensing.

The Overall Index value can also act as a valuable indicator for stock market analysis. A higher value of the index is indicative of better performance in the market.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a flowchart that illustrates the steps involved in the method for estimating the relative impact of patent portfolios, in accordance with an embodiment of the present invention;

FIG. 2 is a flowchart that illustrates a method for computing the Technological Strength Index (TSI) value of a patent in a patent portfolio, in accordance with an embodiment of the present invention;

FIG. 3 is a flowchart that illustrates a method for computing the Economic Impact Index (EII) value of a patent in a patent portfolio, in accordance with an embodiment of the present invention; and

FIG. 4 is a flowchart that illustrates a method for ranking a plurality of companies based on their patent portfolios, in accordance with an embodiment of the present invention.

### DESCRIPTION OF PREFERRED EMBODIMENTS

The present invention is a method for estimating the relative performance of two or more patent portfolios belonging to one or more companies. Further, it also describes a method for ranking a plurality of companies or organizations based on their patent portfolios. In context of the present invention, the term company should be interpreted to include all entities, such as business organizations, government labs, private labs, universities, and other IP generating institutions.

The patent portfolio of a company comprises one or more patents that are assigned to the company. Each patent may belong to one or more market segments of a particular industry. The market segments of an industry can be defined on the basis of different parameters. For example, market segments of the pharmaceutical industry can be defined in different ways, based on parameters such as Therapeutic Areas (TAs), Disease Areas (DAs), or geography. For the purpose of evaluating patent portfolios, as described in the present invention, the market segment to which a patent belongs has been defined as a segment of the industry, in which revenue generation can be potentially impacted by the invention described in the patent. For example, a patent that describes a drug for controlling the growth of malignant tumors will belong to the oncology market segment in the pharmaceutical industry. A patent may also belong to more than one market segment. For example, a patent that describes a drug, which can be used for treating cardiovascular problems, as well as migraine, will belong to two market segments in the pharmaceutical industry, namely, the Cardiovascular and Nervous System TAs. Although the above-mentioned example has been described for the pharmaceutical domain, it will be apparent to one skilled the art that the present invention is equally applicable to other areas of science and engineering such as IT, telecom, photonics and the like.

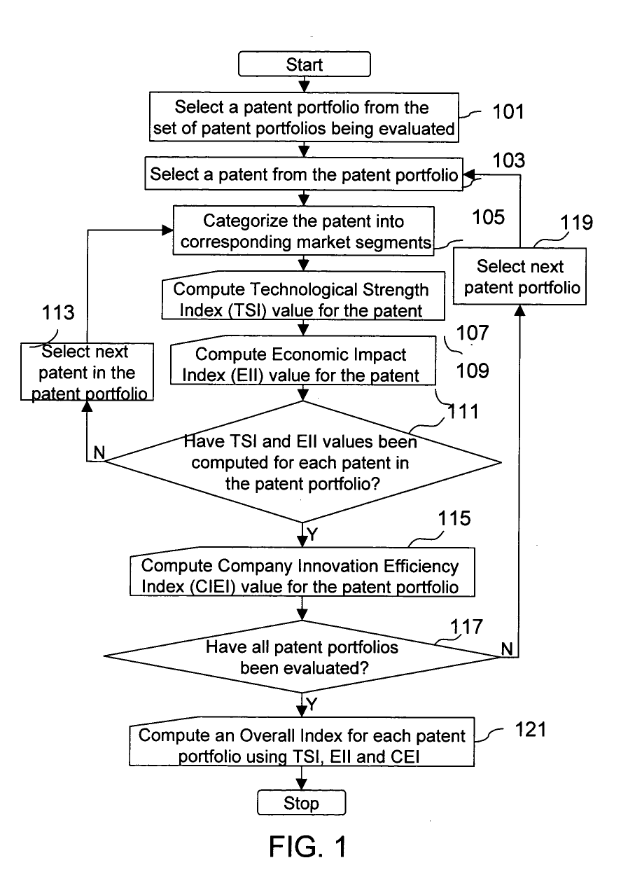

FIG. 1 is a flowchart that illustrates the steps involved in the method for estimating the relative impact of patent portfolios in accordance with an embodiment of the present invention.

At step 101, a patent portfolio is selected from the set of patent portfolios that are to be evaluated. At step 103 a patent that has not already been evaluated so far, is chosen from the selected patent portfolio. At step 105, the selected patent is categorized into the market segment to which it belongs. If the patent belongs to more than one market segment, it is categorized in all such market segments. The categorization of the patent into a market segment can be done manually by browsing through the patent. Alternatively, the categorization can be automated through the use of a software, which can do a keyword or a key concept based search on the patent document. Several techniques, which facilitate such categorization of documents, exist in the art. It will be apparent to any one skilled in the art that any technique that can classify documents into categories can be used to categorize them without deviating from the scope of the present invention.

At step 107, a Technological Strength Index (TSI) is computed for the selected patent. The TSI of a patent is the measure of the technological importance of the patent in its technological domain. In accordance with the present invention, the technological domain of a patent has been defined as the technological segment which has impacted the development of, or can be potentially impacted by, the invention described in the patent. For example, a patent that describes a monoclonal antibody, produced by recombinant DNA technology for treating cancers, would belong to the recombinant DNA technological domain. On similar lines, a patent that describes a method to screen compounds to treat cancer, by inhibiting an enzyme that aids in the transfer of a protein, will belong to the combinatorial chemistry-technological domain.

In accordance with one embodiment of the present invention, the TSI of a patent is computed based on the patent citations of the patent. Patent citations of a patent include the backward references and forward references of the patent. Backward references of a patent are defined as patents to which the patent refers; forward references of a patent are defined as patents, which cite the patent as a backward reference.

The number of backward references of a patent is a measure of the maturity of the technology to which the patent relates. The higher the number of backward references of a patent, the more mature is the technology to which the patent relates. It implies that significant growth has already taken place in the technology to which the patent relates, and it is not a basic patent in its technology chain. On the other hand, a relatively low number of backward references suggest that the patent relates to a technology, which has not yet matured. This implies that not much growth has taken place in the technology chain of the patent, and the patent may be a basic patent in its technology chain. The number of backward references of a patent is indicated in the published version of the patent.

The number of backward references of a patent can also be low because of another reason. The patent might relate to a niche sub-segment of a technology. In case very low levels of research and development activity are taking place in that sub-segment, the patent relating to this technology sub-segment is likely to have very few backward references. However, even in such a case, the patent can be said to be a basic patent in the technology chain in its technology sub-segment.

In some cases, it might be required to compare a patent ‘C’ of one technological domain with a patent ‘D’ of another technological domain. The two technological domains might have very different rates of research and development activity in them. Due to this reason, the patents ‘C’ and ‘D’ are likely to have a different number of backward references in them. Hence, the use of number of backward references as a measure of the maturity of technology (position of the technology described by the patent in the technology chain), to which the patent relates, might suffer from limitations. In such cases, it becomes important to normalize the number of backward references of the two patent ‘C’ and ‘D’ before they can be compared to each other.

In one embodiment of the present invention, the number of backward references of a first patent belonging to a first technological segment, which needs to be compared with a second patent of a second technological segment, can be normalized with respect to the number of backward references of all other patents corresponding to the first technology domain. A similar normalization can also be done to normalize the number of backward references of the second patent, with respect to the number of backward references of all other patents corresponding to the second technology domain.

In one embodiment of the present invention, the other patents belonging to the same technological domain as the patent to be normalized, say patent ‘C’, are identified using the IPC (International Patent Classification) classes to which patent ‘C’ belongs. Patent ‘C’ may belong to one or more than one different IPC classes. All patents belonging to one or more of the IPC classes to which patent ‘C’ belongs are identified. This can be done using the typical Boolean searches in patent databases. An average value of the number of backward references of all such identified patents is calculated. Subsequently, the number of backward references of patent ‘C’ are normalized with respect to the average value of backward references, as calculated above. The same methodology is followed for normalizing the number of backward references of patent ‘D’. Once the number of backward references of both patent ‘C’ and patent ‘D’ have been normalized, they can be compared with each other to get a measure of the relative maturity of the technologies described by patents ‘C’ and ‘D’.

It will be apparent to a person skilled in the art that the above-mentioned normalization of the number of backward references can be done in several other statistical measures, and by taking into account several other factors like filing/publication date of the patent, etc. The above-mentioned embodiment describes just one way of performing this normalization and is not meant to limit the invention. The number of forward references of a patent is a measure of the innovation initiated by the patent in its technological domain. The higher the number of forward references, the more innovation it has initiated in its technological domain. Similarly, the lower the number of forward references of a patent, the less the innovation it has initiated in its technological domain. However, it is worth noting that the number of forward references of a patent is a time-dependent variable. An older patent, owing to its longer existence in the public domain, is likely to have a higher number of forward references than a relatively recent patent. Therefore, in one embodiment of the present invention, only patents belonging to the same time domain (with comparable filing dates or publication dates) are compared to each other, based on the number of forward references.

In accordance with one embodiment of the present invention, the time domain is defined as one year. That is, in accordance with this embodiment of the present invention, only patents that are published in the same year are compared with each other in terms of their TSI values. For example, patent ‘A’, granted in the year 1998, and patent ‘B’, granted in the same year, can be compared in terms of their TSI values. However, neither patent ‘A’ nor patent ‘B’ can be compared to another patent ‘C’, which was granted in the year 2000, in terms of their TSI values. The number of forward references of a patent is indicated in the published version of the patent.

However, in accordance with another embodiment of the present invention, the innovation initiated by patents of different time domains (that is, with significantly different filing dates/publication dates) can also be compared to each other. This is achieved by normalizing the number of forward references of each patent with respect to the number of forward references of all other patents in the same technological domain as the patent, and corresponding to the same time domain as the patent. For example, consider a case when the measure of innovation initiated by a patent ‘E’, which is published in the year 1995, in its technological domain, needs to be compared with that of a patent ‘F’, which is published in the year 2002. Patent ‘E’, owing to its longer period of existence in the public domain than patent ‘F’, is likely to have a higher number of forward references compared to patent ‘D’.

In order to remove this inherent bias, the number of forward references of each patent can be normalized with respect to the number of forward references of all patents in the technological domain of the patent, and belonging to the year in which the patent was published. In one embodiment of the present invention, the other patents belonging to the same technological domain as the patent to be normalized, say patent ‘E’, are identified using the IPC classes to which patent ‘E’ belongs. All patents published in the same year as the publication year of patent ‘E’, and belonging to one or more of the IPC classes to which patent ‘E’ belongs, are identified. This can be done using the typical Boolean searches in patent databases. An average value of the number of forward references of all such identified patents is calculated. Subsequently, the number of forward references of patent ‘E’ are normalized with respect to the average value of forward references, as calculated above. The same methodology is followed for normalizing the number of forward references of patent ‘F’. Once the number of forward references of both patent ‘E’ and patent ‘F’ have been normalized, they can be compared with each other to get a measure of the relative innovation initiated by patents ‘E’ and ‘F’ in their corresponding technological domains.

It will be apparent to a person skilled in the art that the above-mentioned normalization of the number of backward references can be done in several other statistical measures, and by taking into account other patent-specific parameters as well. The above-mentioned embodiment describes just one way of performing this normalization and is not meant to limit the invention.

At step 109, an Economic Impact Index (EII) is computed for the selected patent. The EII of a patent is a measure of the economic importance of the patent in the market segment(s) to which it belongs. It is measured on the basis of the economic impact generated by the patent in the market segment(s) to which it belongs. That is, the EII of the patent is measured in terms of the revenue-generating ability of the patent in the market segment(s) to which it belongs. Further, the EII value is computed for a pre-decided year, during which the economic impact of the patent is going to be measured. For example, the EII value for the year 2000 of a patent, which was published in an earlier year, signifies the economic impact of the patent in the year 2000.

At least one parameter from a set of three different market segment-specific parameters is used to compute the EII value of a patent. These market segment-specific factors include the market size of each market segment to which the patent belongs, the market growth rate of each market segment to which the patent belongs, and the market share of the company in each market segment to which the patent belongs. The market size, market growth rate and market share values of the pre-decided year, in which the economic impact of the patent is going to be measured, are used for the purpose of computing the value of the EII of the patent.

For example, assume that a patent granted in the year 1998 belongs to the anti-infectives market segment, and its economic impact needs to be measured in the year 2000. In this case, the EII for the patent in the anti-infectives market segment is computed using the market size and market growth rate of the anti-infectives market segment, and the market share of the company in the anti-infectives market segment in the year 2000.

At step 111, it is determined whether the TSI and EII values have been computed for all patents in the selected patent portfolio. If the EII and TSI values have not been computed for all patents in the patent portfolio, step 113 is performed. At step 113, the next patent is selected from the patent portfolio and steps 103-109 are repeated for it. However, if it is determined at step 111 that the TSI and EII values for all patents in the selected patent portfolio have been computed, then step 115 is performed.

At step 115, a Company Innovation Efficiency Index (CIEI) is computed for the selected patent portfolio. The CIEI of a company's patent portfolio is indicative of the company's economic efficiency in coming up with innovations. The CIEI is computed, based on the company's R&D expenditure over a period of time and the number of patents granted to the company during a particular period of time.

It is typically the case that the R&D investment made by a company in a particular year leads to tangible inventions (and the associated IP) only after a ‘gestation period’. The ‘gestation period’ is the time frame that is required for converting the R&D investment of a company into inventions. This ‘gestation period’ may vary from industry to industry, and from invention to invention. Therefore, while calculating the CIEI value of a company's patent portfolio (or the patent sub-folio) for a particular period, it is important to consider the number of patents granted to the company during the period; and the R&D expenditure of the company for a time-period, which is calculated by subtracting the ‘gestation period from the period for which CIEI value has to be calculated.

In one embodiment of the present invention, the CIEI value of a company's patent portfolio for a period (year ‘X’ to year ‘Y’) is calculated by dividing the R&D expenditure of the company ‘β’ years (β denotes the average ‘gestation period’ of the innovations of the company) prior to the period, by the number of patents granted to the company during the period (year ‘X’ to year ‘Y’). For example, if the CIEI value for a company's patent portfolio has to calculated for the period 1998 to 2002, and the average gestation period (β) of the company's innovations is 5 years, then

CIEI _{company for 1998-2002}=(R&D expenditure for the period during the period 1993-1997)/(Number of patents granted to the company during the period 1998-2002)

In cases where the average ‘gestation period’ (β) is difficult to estimate for a company's innovations, a statistical measure of the R&D expenditure of the company over a statistically significant period can be used for the purpose of calculation of CIEI. In one embodiment of the present invention, an average of the R&D expenditure of the company over a significant period is used as a measure of R&D expenditure of the company per year. This average value can then be used to calculate the CIEI value for the company over the desired period.

The calculation of CIEI is also dependent on the nature of the patent portfolio being evaluated. A company may be operating in different technological segments of a technological area. For example, consider a company that is operating only in four technological sub-segments—PSTN, Ethernet, Broadband and Optical Networks of the ‘wired-telecom’ technological area. In this example, it might be that the company only wishes to evaluate its sub-folio corresponding to its operations in the Broadband sub-segment. In such a case, the CIEI value for the company's operations in the Broadband sub-segment for a period will be calculated as a function of the R&D expenditure of the company on its Broadband operations during the period; and the number of patents granted to the company in the Broadband sub-segment over a period, which is ‘β’ years (‘gestation period’ for the company's innovations in the Broadband sub-segment in this example) later than the period for which the R&D expenditure has been calculated.

Further, in cases where the ‘gestation period’ (β) is difficult to estimate for a company's innovations in a sub-segment, a statistical measure of the R&D expenditure of the company in the sub-segment over a statistically significant period can be used for the purpose of calculation of CIEI. In one embodiment of the present invention, an average of the R&D expenditure of the company in the sub-segment over a significant period is used as a measure of the per-year R&D expenditure of the company in the sub-segment. This average value can then be used to calculate the CIEI value for the company over the desired period in the sub-segment.

At step 117, it is determined whether the patent portfolios of all companies have been evaluated. If there are patent portfolios that have not been evaluated, then step 119 is performed. At step 119, the next patent portfolio is selected and steps 103-115 are repeated for it. However, it is determined at step 117 that all patent portfolios have been evaluated, then step 121 is performed. At step 121, the Overall Index value is computed for each patent portfolio, using the TSI and EII values for all patents in the respective patent portfolios, and the CIEI of the respective patent portfolios. Where f indicates a mathematical or other function:

Overall Index_{patent portfolio}=f(TSI, EII, CIEI)

The Overall Index values of the evaluated patent portfolios can then be used to compare the evaluated patent portfolios. In one embodiment of the present invention, when the patent portfolios are compared, the company with a higher Overall Index value is considered to have performed better than the company with a lower Overall Index value in terms of its innovation practices.

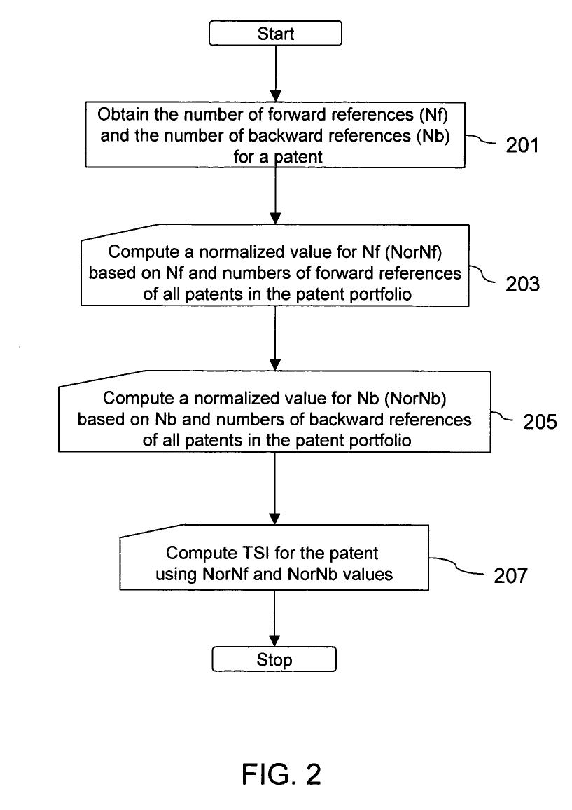

FIG. 2 is a flowchart that illustrates a method for computing the TSI value of a patent in a patent portfolio, in accordance with one embodiment of the present invention. At step 201, a number of forward references (Nf), and a number of backward references (Nb) are obtained for the patent. At step 203, the normalized value of the number of forward references of the patent (NorNf) is computed, based on the number of forward references of all patents in the patent portfolio. At step 205, a normalized value for the number of backward references (NorNb) is computed, based on the number of backward references of all patents in the patent portfolio.

Normalized values for the number of forward references and backward references of a patent are computed in order to nullify the effect of the technological domain of the patent, so that the patent can be compared with a patent belonging to another technological domain. Two technological domains may have different rates of technological growth. Hence, the number of backward and forward references of two patents belonging to two different technological domains can vary significantly. In order to remove any bias arising due to the different rates of technological growth, the Nf and Nb values of each patent in the patent portfolio are normalized, based respectively on the Nf and Nb values of all patents in the patent portfolio.

Alternatively, the values of Nf and Nb can be normalized against the Nf and Nb values of all the patents that have been granted till date.

At step 207, the TSI for the patent is computed using the NorNf and NorNb values.

TSI=f(NorNf, NorNb)

In one embodiment, the NorNf value of the patent is computed by dividing (i.e. function f is division) the number of forward references of the patent by the maximum value of the number of forward references (Nfₘₐₓ) of all patents in the patent portfolio. That is,

NorNf=f(Nf/Nfₘₐₓ)

It will be apparent to one skilled in the art that although the maximum value of the number of forward references of all patents has been mentioned, the normalization of Nf can be conducted by using any other value for the number of forward references. For example, the average value, mode, or median values of the number of forward references of all analyzed patents can be used to normalize the Nf value of a patent. Alternatively, the average value of the number of forward references can be computed for all patents granted till date, and this value can be used to normalize the Nf of a patent in the analysis.

In one embodiment, the NorNb value of the patent is computed by dividing the number of backward references of the patent by the maximum value of the number of backward references (Nbₘₐₓ) of all patents in the patent portfolio. That is,

NorNb=f(Nb/Nbₘₐₓ)

It will be apparent to one skilled in the art that although the maximum value of the number of backward references of all patents has been mentioned, the normalization of Nb can be done by using any other value for the number of backward references. For example, the average value, mode or median values of the number of forward references of all analyzed patents can be used to normalize the Nb value of a patent. Alternatively, the average value of the number of backward references can be computed for all patents granted till date, and this value can be used to normalize Nb for a patent in the analysis.

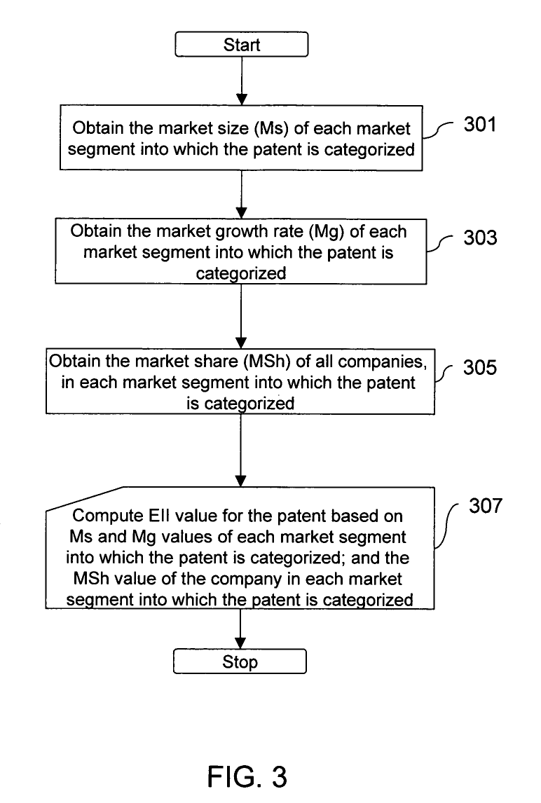

FIG. 3 is a flowchart that illustrates a method for computing the EII value of a patent in a patent portfolio, in accordance with one embodiment of the present invention.

At step 301, the market size (Ms) is obtained for each market segment to which one or more patents in the patent portfolio belong. At step 303, the market growth rate (Mg) is obtained for each market segment to which one or more patents in the patent portfolio belong. At step 305, the market share (MSh) of all companies is obtained in each market segment to which one or more patents in the patent portfolio belong. At step 307, the EII for the patent is computed based on the Ms, Mg and MSh of each market segment into which the patent is categorized.

EII=f(Ms₁,Mg₁,MSh₁,Ms₂,Mg₂,MSh₂ . . . Msᵢ,Mgᵢ,MShᵢ)
where i=1 to n, where n is the number of market segments into which the patent is categorized

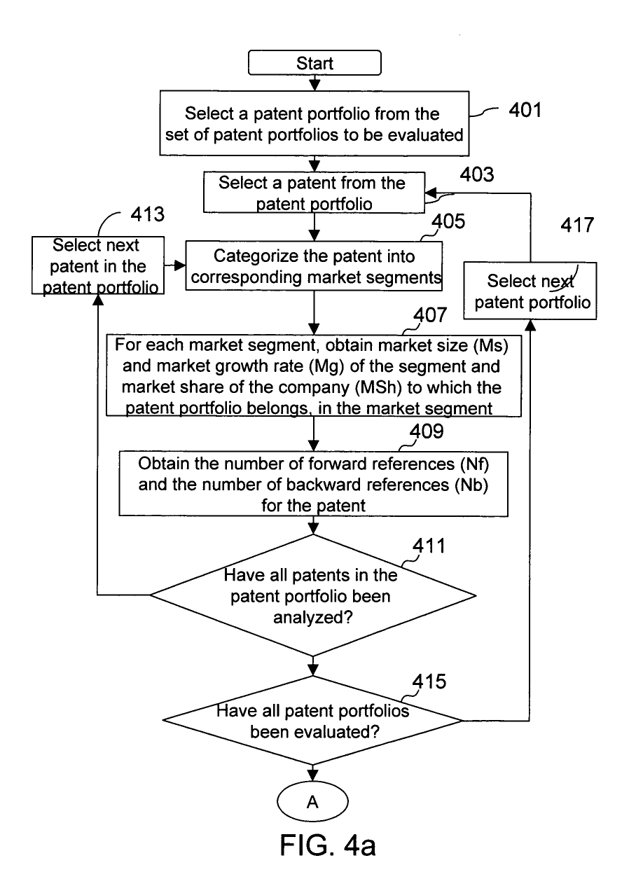

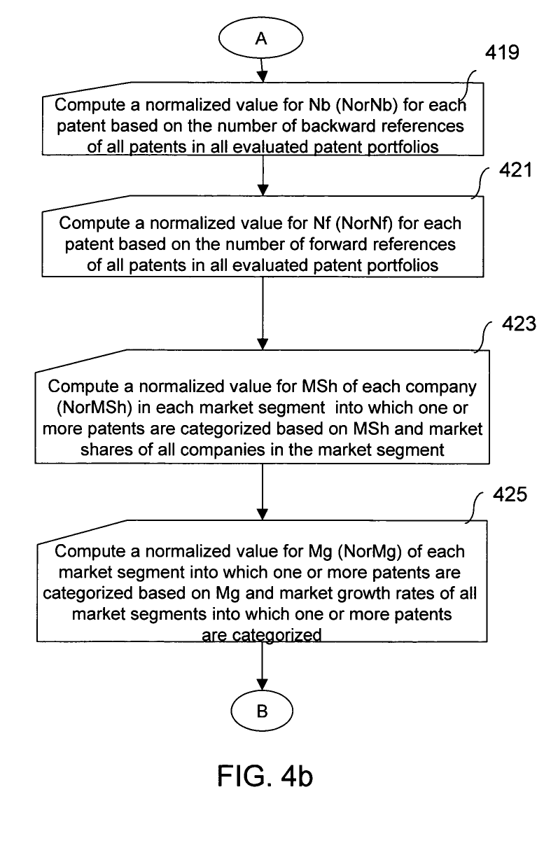

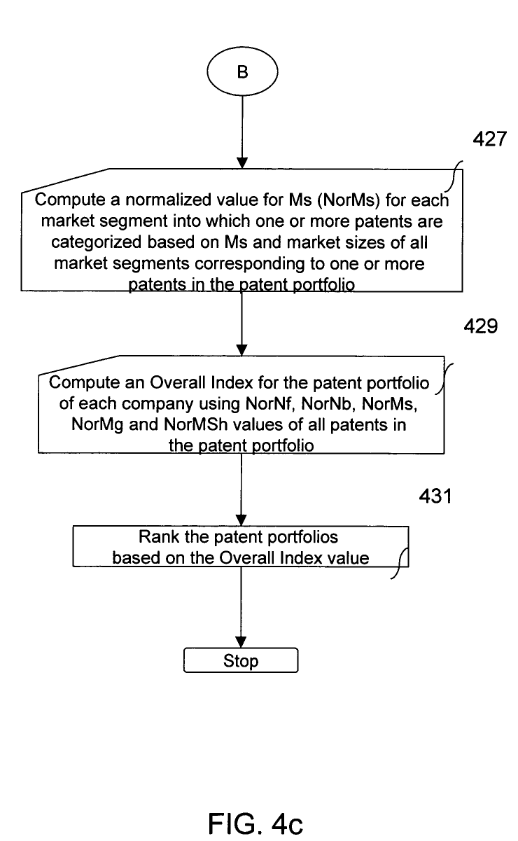

FIG. 4 is a flowchart that illustrates a method to rank a plurality of companies based on their patent portfolios, in accordance with one embodiment of the present invention.

At step 401, a patent portfolio is selected from a set of patent portfolios to be evaluated. At step 403, a patent is selected from the selected patent portfolio.

At step 405, the selected patent is categorized into one or more market segments to which it belongs. At step 407, the market size (Ms) and the market growth rate (Mg) is obtained for each market segment to which the patent belongs, along with the market share (MSh) of the company in each market segment to which the patent belongs.

At step 409, the Nf and Nb values of each patent are obtained.

At step 411, it is determined whether all the patents in the selected patent portfolio have been analyzed. If all the patents have not been analyzed, then step 413 is performed. At step 413, the next patent is selected and steps 405 to 409 are repeated for it. However, if it is determined at step 411 that not all the patents have been analyzed, then step 415 is performed.

At step 415, it is determined whether all the patent portfolios of all the companies being analyzed have been evaluated. A patent portfolio is said to have been evaluated when all patents, which constitute the patent portfolio, have been analyzed. If it is determined that all patent portfolios have not been evaluated, step 417 is performed. At step 417, the next patent portfolio, which has not been evaluated, is selected from the set of patent portfolios to be evaluated, and steps 403 to 411 are performed for the next selected company's patent portfolio. However, if it is determined at step 415 that all patent portfolios have been evaluated, then step 417 is performed.

At step 419, a NorNb value is computed for each analyzed patent in each evaluated patent portfolio. Calculation of NorNb is based on the number of backward references of all analyzed patents in all evaluated patent portfolios.

In one embodiment of the present invention, the NorNb value of a patent is computed by dividing the Nb value of the patent by the maximum value of the number of backward references among the number of backward references of all patents in all evaluated patent portfolios.

However, it will be apparent to a person skilled in the art that instead of using the maximum value of the number of backward references of all patents of each evaluated patent portfolio for the purpose of computing the NorNb value of the patent, other statistical measures can also be used. For example, mean, median or mode, corresponding to the distribution of the Nb values of patents in the evaluated patent portfolios, can be used for the purpose of calculation of NorNb.

At step 421, the NorNf value of the selected patent is computed for each analyzed patent in each evaluated patent portfolio. Calculation of the NorNf value is based on the number of forward references of all analyzed patents in all evaluated patent portfolios.

In one embodiment of the present invention, the NorNf value of the selected patent is computed by dividing the Nf value of the selected patent by the maximum value of the number of forward references among the number of forward references of all patents in all evaluated patent portfolios.

However, it will be apparent to a person skilled in the art that instead of using the maximum value of the number of forward references of all patents of each evaluated patent portfolio for the purpose of computing the NorNf value of the patent, other statistical measures can also be used. For example, the mean, median or mode corresponding to the distribution of the Nf values of patents in the evaluated patent portfolios can be used for the purpose of calculation of NorNf.

At step 423, the normalized market share value (NorMSh) is computed for the market share of each company in each market segment, to which one or more patents belong. The NorMSh value of a company in a market segment is computed as a function of the market share of the company in the market segment, and the market share values of all other companies in the market segment.

In one embodiment of the present invention, the NorMSh value of a company in a market segment is computed by dividing the market share of the company in the market segment by the maximum value (MShₘₐₓ) among the market shares of all companies (to which the evaluated patent portfolios belong) in the market segment.

NorMSh=f(MSh,MShₘₐₓ)

However, it will be apparent to a person skilled in the art that the normalized market share value can also be computed based on other statistical measures corresponding to the distribution of the MSh values of different companies in the market segment.

At step 425, the normalized value of the market growth rate (NorMg) of each market segment, into which one or more patents are categorized, is computed. The NorMg value is computed, based on the market growth rate (Mg) value of the market segment and the Mg values of all other market segments to which one or more patents belong.

In one embodiment of the present invention, the NorMg value for a market segment is computed by dividing the market growth rate of the market segment by the maximum growth rate (Mgₘₐₓ) among all market segments, to which one or more patents belong.

NorMg=f(Mg,Mgₘₐₓ)

However, it will be apparent to a person skilled in the art that instead of using the maximum value of the market growth rate among all market segments, other statistical measures, such as the mean, median or mode of the distribution of Mg values of market segments, can also be used.

At step 427, the normalized market size value (NorMs) is computed for each market segment, to which one or more patents belong. The calculation of the NorMs value for a market segment is computed, based on the market size of the market segment and the market sizes of all market segments to which one or more patents belong.

In one embodiment of the present invention, the NorMs value is computed by dividing the market size of the market segment by the maximum market size value (MSₘₐₓ) among all market segments to which one or more patents belong.

NorMs=f(Ms,Msₘₐₓ)

At step 429, an Overall Index is computed for the patent portfolio being evaluated. The calculation of Overall Index for a patent portfolio comprises two sub-steps. In the first sub-step, an Overall Index value is computed for each patent in the patent portfolio. The Overall Index of a patent is computed based on the NorNb and NorNf values of the patent, the NorMs and NorMg values of the market segment to which the patent belongs, and the NorMSh value of the company in each market segment to which the patent belongs.

Overall Indexₚₐₜₑₙₜ=f(NorNf, NorNb, NorMSh, NorMg, NorMs)

For example, if a company's patent belongs to two market segments, the Overall Index for the patent is computed as a function of the NorNb and NorNf values of the patent, the NorMs and NorMg values of each of the two market segments, and the NorMSh values of the company in each of the two market segments.

In one embodiment of the present invention, the Overall Index of a patent is computed by multiplying the product of the NorNb and NorNf values of the patent with the product of the NorMs, NorMg and NorMSh values of each market segment, to which the patent belongs.

$$Overall {Index}_{patent} = NorNf * NorNb * {\sum }_{i = 1}^{i = n} {( NorMSh * NorMg * NorMs )}_{segment\_i}$$

where i=1 to ‘n’; and
‘n’ is the number of market segments to which the patent belongs.

In the second sub-step, the Overall Index of a patent portfolio is computed as a function of the overall indices of all patents which constitute the patent portfolio. In one embodiment of the present invention, the Overall Index of the patent portfolio is computed as a summation of the overall indices of all patents which constitute the patent portfolio.

$$Overall {Index}_{patent portfolio} = {\sum }_{j = 1}^{j = m} {( Overall\_index )}_{patent\_j}$$

where j=1 to m,
‘m’ is the number of patents in the patent portfolio

At step 431, the evaluated patent portfolios are ranked based on the Overall Index value computed for the patent portfolios. In one embodiment of the present invention, a patent portfolio with a higher Overall Index is assigned a higher rank compared to a patent portfolio with a lower Overall Index rating. The higher Overall Index value of a patent portfolio implies that the company to which the patent portfolio belongs has performed relatively better in terms of its innovation practices, compared to a company whose patent portfolio has a lower Overall Index value.

In another embodiment of the present invention, a Company Technological Strength Index (CTSI) value is also computed for each patent portfolio. The CTSI value of a patent portfolio is indicative of its technological strength, and is computed based on the TSI values of all patents in the patent portfolio.

In one embodiment of the present invention, the CTSI value of a patent portfolio is computed as a summation of the TSI values of all patents in the patent portfolio. That is,

$${CTSI}_{patent portfolio} = {\sum }_{k = 1}^{k = t} {TSI}_{patent\_k}$$

where k=1 to ‘t’

and ‘t’ is the number of patents in the patent portfolio

In yet another embodiment of the present invention, the CEII value is computed for the patent portfolio of each company. The CEII value of a patent portfolio is indicative of the cumulative economic impact of all patents in the patent portfolio and is computed based on the EII values of all patents in the portfolio.

In one embodiment of the present invention, the CEII value of a patent portfolio is computed as a summation of the EII values of all patents in the patent portfolio. That is,

$${CEII}_{patent portfolio} = {\sum }_{k = 1}^{k = t} {EII}_{patent\_k}$$

where k=1 to ‘t’

and ‘t’ is the number of patents in the patent portfolio

In another embodiment of the present invention, the Overall Index value of a patent portfolio is computed by multiplying the CTSI, CEEI and CIEI values of the patent portfolio. That is,

Overall Index_{patent portfolio}=CTSI_{portfolio}*CEII_{portfolio}*CIEI_{portfolio}

Once the CTSI and CEII values have been computed for the patent portfolios, companies can also be ranked, based on the values of the CTSI or CEII values of their patent portfolios. For example, assume that two companies are being compared based on their CTSI values. The company with a higher CTSI value can be said to have generated a higher technological impact on its technological domain, as compared to the company with a relatively lower CTSI value.

Similarly, if we compare two companies based on their CEII values, it can be said that the company with a higher CEII value has created a higher economic impact on its market segment as compared to the company with a relatively lower CEII value.

The present invention has the advantage that a comparison of two or more patent portfolios takes into account the technological impact and the economic impact created by the patents. This implies that the indices computed in the present invention provide reliable indicators regarding the relative performance of the companies in terms of the success of their innovation practices.

Further, it will be apparent to a person skilled in the art that instead of comparing the patent portfolios of two different companies, sub-folios of two or more companies can also be compared to each other. All the above-mentioned indices can be calculated for two or more sub-folios of the same company. Subsequently, the sub-folios can be compared to each other based on a relative comparison of one or more of the indices calculated above.

For example, a medical devices company may want to compare its patent sub-folios in two different technological segments, e.g., the sub-folios relating to diabetes care diagnostics and molecular diagnostic tools. The two sub-folios can be evaluated to calculate the Overall Index and other index values. Subsequently, the medical devices company can compare the sub-folios in these two areas based on the calculated indices, in order to derive insights into the relative functioning and innovation impact of these sub-folios.

The method for comparing a plurality of patent portfolios or any of its parts, as described in the present invention, can be implemented manually or through the use of a processing machine. Typical examples of a processing machine include a general-purpose computer, a programmed microprocessor, a micro-controller, a peripheral integrated circuit element, and other devices or arrangements of devices, which are capable of implementing the steps that constitute the methodology of the present invention.

The processing machine executes a set of instructions that are stored in one or more storage elements, in order to process data in accordance with the method steps of the present invention. The storage element may be in the form of a database or a physical memory element present in the processing machine.

The set of instructions may include various instructions that instruct the processing machine to perform specific tasks such as the steps that constitute the methodology of the present invention. The set of instructions may be in the form of a program or software. The software may be in various forms such as system software, or in the form of application software like MS Excel, MS Access, and so forth. The software might also include modular programming in the form of object-oriented programming. The processing of data by the processing machine may be in response to user commands, to results of previous processing, or to a request made by another processing machine.

It is not necessary that the various processing machines and/or storage elements are physically located in the same geographical location. The processing machines and/or storage elements may be located in geographically distinct locations, and connected to each other over a network. The network can be an intranet, an extranet, the Internet, or any client server models that enable communication.

Different user interfaces can be utilized to allow a user to interface with the processing machine or machines that are used to implement the present invention. User interface is used by the processing machine to interact with a user, in order to convey or receive information. The user interface could be any hardware, software, or a combination of hardware and software used by the processing machine, that allows a user to interact with the processing machine. The user interface may be in the form of a dialogue screen, and may include various associated devices to enable communication between a user and a processing machine.

While the preferred embodiments of the invention have been illustrated and described, it is clear that the invention is not limited to only these embodiments. Numerous modifications, changes, variations, substitutions and equivalents are apparent to those skilled in the art, without departing from the spirit and scope of the invention, as described in the claims.

What is claimed is:

1. A method of estimating the relative impact of two or more patent portfolios of one or more companies, each patent portfolio of each company comprising patents belonging to at least one market segment, the market segment having a market size and a market growth rate, each company having a market share in one or more market segments, the method comprising the steps of:
a. categorizing a patent of the patent portfolio of a company into at least one market segment;
b. computing a Technological Strength Index (TSI) value for the patent, the TSI value of the patent being computed based on the number of forward and backward references of the patent;
c. computing an Economic Impact Index (EII) value for the patent, the EII value being computed based on at least one parameter from a set of parameters including market size of each market segment into which the patent is categorized, market growth rate of each market segment into which the patent is categorized, and market share of the company in each market segment into which the patent is categorized;
d. repeating steps a to c for each patent in the patent portfolio of the company;
e. computing a Company Innovation Efficiency Index (CIEI) value for the patent portfolio of the company, the efficiency impact value being computed based on Research and Development (R&D) expenditure of the company and number of patents in the patent portfolio of the company;
f. repeating steps a to e for each company; and
g. computing an Overall Index value for each patent portfolio, the Overall Index value being computed using at least one parameter from a set of parameters including the TSI values for all patents in the patent portfolio of the company, the EII values for all patents in the patent portfolio of the company, and the CIEI value for the patent portfolio of the company,
whereby the Overall Index values for portfolios indicate the relative impact of their respective patent portfolios.

2. The method of claim 1 wherein the step of computing the TSI value for the patent further comprises the steps of:
a. computing a normalized value for the number of backward references of the patent, the normalization being done based on the numbers of backward references of all patents in the patent portfolios of all companies;
b. computing a normalized value for the number of forward references of the patent, the normalization being done based on the numbers of forward references of all patents in the patent portfolios of all companies; and
c. computing the TSI value for the patent using the normalized value for the number of forward references and the number of backward references.

3. The method of claim 2 wherein computing the normalized value for the number of backward references of the patent further comprises the steps of:
a. determining the maximum value of backward references among the number of backward references for all patents in the patent portfolios of all companies; and
b. normalizing the value for the number of backward references of the patent by dividing it by the determined maximum value of backward references.

4. The method of claim 2 wherein computing the normalized value for the number of forward references of the patent further comprises the steps of:
a. determining the maximum value of forward references among the number of forward references for all patents in the patent portfolios of all companies; and
b. normalizing the value for the number of forward references of the patent by dividing it by the determined maximum value of forward references.

5. The method of claim 1 wherein computing the Economic Impact Index (EII) value for the patent further comprises the steps of:
a. computing a normalized value for market size of each market segment into which the patent is categorized, the normalization being done based on market sizes of all market segments, to which any patent of any patent portfolio belongs;
b. computing a normalized value for market growth rate of each market segment into which the patent is categorized, the normalization being done based on market growth rates of all market segments, to which any patent of any patent portfolio belongs;
c. computing a normalized value for market share of the company in each market segment into which the patent is categorized, the normalization of the market share of the company in a market segment being done based on the market shares of all companies in the market segment; and
d. computing the EII value for the patent using at least one parameter from the set of parameters including the normalized value for market size of each market segment into which the patent is categorized, the normalized value for market growth rate of each market segment into which the patent is categorized, and the normalized value of the market share of the company in each market segment into which the patent is categorized.

6. A method for ranking a plurality of companies based on their patent portfolios, the patent portfolio of each company comprising patents belonging to a plurality of market segments, each market segment having a market size and a market growth rate, each company having a market share in one or more market segments, the method comprising the steps of:
a. categorizing a patent of the patent portfolio of a company into at least one market segment;
b. obtaining market size for each market segment into which the patent is categorized;
c. obtaining market growth rate for each market segment into which the patent is categorized;
d. obtaining market share of the company in each market segment into which the patent is categorized;
e. obtaining the Research and Development (R&D) expenditure of the company;
f. obtaining a number of backward references for the patent;
g. obtaining a number of forward references for the patent;
h. repeating step a to f for each patent in the patent portfolio of the company;
i. computing a Company Innovation Efficiency Index (CIEI) value for the patent portfolio of the company, the CIEI value being computed based on R&D expenditure of the company and number of patents in the patent portfolio of the company;
j. repeating steps (a) to (i) for the patent portfolio of each of the plurality of companies;
k. computing a normalized value for the number of backward references (NorNb) of each patent in the patent portfolios of the plurality of companies;
l. computing a normalized value for the number of forward references (NorNf) of each patent in the patent portfolios of the plurality of companies;
m. computing a normalized value for market share (NorMSh) of the company in each market segment into which one or more patents are categorized, the normalization being done based on market shares of all the companies in the market segment;
n. computing a normalized value for market growth rate (NorMg) of each market segment into which one or more patents are categorized, the normalization being done based on market growth rates of all market segments into which one or more patents are categorized;
o. computing a normalized value for market size (NorMs) of each market segment into which one or more patents are categorized, the normalization being done based on market sizes of all market segments into which one or more patents are categorized; and
p. computing an Overall Index value for the patent portfolio of each of the plurality of companies, the index value being computed using the values obtained in the steps (i), (k), (l), (m), (n) and (o);
whereby the rank of a company's patent portfolio is determined by the value of the computed Overall Index value.

7. The method of claim 6 wherein NorNb of a patent is computed by normalizing the number of backward references of the patent using the numbers of backward references of all patents in the patent portfolios of the plurality of companies.

8. The method of claim 7 wherein the normalized value NorNb of a patent is computed by normalizing the number of backward references of the patent using the maximum value of the number of backward references among all patents in the patent portfolios of the plurality of companies.

9. The method of claim 6 wherein NorNf of a patent is computed by normalizing the number of forward references of the patent using the numbers of forward references of all patents in the patent portfolios of the plurality of companies.

10. The method of claim 9 wherein the normalized value NorNf of a patent is computed by normalizing the number of forward references of a patent using the maximum value of the number of forward references among all patents in the patent portfolios of the plurality of companies.

11. The method of claim 6 wherein the normalized value for market size (NorMs) of the market segment is computed based on the maximum market size among market sizes of all market segments into which one or more patents have been categorized.

12. The method of claim 6 wherein the normalized value for market growth rate of the market segment is computed based on the maximum market growth rate among the market growth rates of all market segments into which one or more patents are categorized.

13. The method of claim 6 wherein the normalized value for market share of the company in the market segment is computed based on the maximum market share of any of the plurality of companies in the market segment.

14. The method of claim 6 further comprising the step of computing a Company Technology Strength Index (CTSI) value for a company, the CTSI value for the company being computed as a summation of the products obtained by multiplying the NorNf and NorNb values of each patent in the patent portfolio of the company, as per the equation,
$${CTSI}_{patent portfolio} = {\sum }_{k = 1}^{k = t} {TSI}_{patent\_k}$$
where k=1 to ‘t’
and ‘t’ is the number of patents in the patent portfolio.

15. The method of claim 6 further comprising the step of computing a Company Economic Impact Index (CEII) value for a company, the CEII value being computed as a summation of the products obtained by multiplying the NorMs, MorMg and NorMSh values of each patent in the patent portfolio of the company, as per the equation,
$${CEII}_{patent portfolio} = {\sum }_{k = 1}^{k = t} {EII}_{patent\_k}$$
where k=1 to ‘t’
and ‘t’ is the number of patents in the patent portfolio.

16. The method of claim 6 wherein the Overall Index for the patent portfolio of a company is computed using the equation:
Overall Index_{patent portfolio}=CTSI_{portfolio}*CEII_{portfolio}*CIEI_{portfolio}

17. A computer program product for estimating the relative impact of two or more patent portfolios of one or more companies, the patent portfolio of each company comprising patents belonging to at least one market segment, the market segment having a market size and a market growth rate, each company having a market share in one or more market segments, the computer program product comprising:
a. program instruction means for categorizing each patent of the patent portfolio of a company into at least one market segment;
b. program instruction means for computing a Technological Strength Index (TSI) value for each patent of the patent portfolio of the company, the TSI value of the patent being computed based on the number of forward and backward references of the patent;
c. program instruction means for computing an Economic Impact Index (EII) value for each patent, the EII value being computed based on at least one parameter from a set of parameters including market size of each market segment into which the patent is categorized, a market growth rate of each market segment into which the patent is categorized, and a market share of the company in each market segment into which the patent is categorized;;
d. program instruction means for computing a value for Company Innovation Efficiency Index (CIEI) value of the patent portfolio of the company, the CIEI value being computed based on Research and Development (R&D) expenditure of the company and number of patents in the patent portfolio of the company;
e. program instruction means for computing an Overall Index value for the patent portfolio of each company, the Overall Index value being computed using at least one parameter from a set of parameters including the TSI values for all patents in the patent portfolio of the company, the EII values for all patents in the patent portfolio of the company, and the CIEI value for the patent portfolio of the company.

18. The computer program product of claim 17 wherein the program instruction means for computing the TSI value for the patent further comprises:
a. program instruction means for computing a normalized value for the number of backward references (NorNb) of the patent, the normalization being done based on the numbers of backward references of all patents in the patent portfolios of all companies;
b. program instruction means for computing a normalized value for the number of forward references (NorNf) of the patent, the normalization being done based on the numbers of forward references of all patents in the patent portfolios of all companies; and
c. program instruction means for computing the TSI value for the patent using the normalized value for the number of forward references and the number of backward references.

19. The computer program product of claim 18 wherein the program instruction for computing normalized value of the number of backward references (NorNb) of the patent further comprises:
a. program instruction means for determining the maximum value of backward references (Nbₘₐₓ) among the number of backward references for all patents in the patent portfolios of all companies; and
b. program instruction means for normalizing the value of the number of backward references of the patent by dividing it by the determined Nbₘₐₓ value.

20. The computer program product of claim 18 wherein the program instruction means for computing the normalized value of the number of forward references of the patent further comprises:
a. program instruction means for determining the maximum value of forward references (Nfₘₐₓ) among the number of forward references for all patents in the patent portfolios of all companies; and
b. program instruction means for normalizing the value of the number of forward references of the patent by dividing it by the determined Nfₘₐₓ value.

21. The computer program product of claim 17 wherein the program instruction means for computing the EII value of the patent further comprises:
a. program instruction means for computing a normalized value for market size of the market segment into which the patent is categorized, the normalization being done based on market sizes of the market segments into which one or more patents have been categorized;
b. program instruction means for computing a normalized value for market growth rate of each market segment into which the patent is categorized, the normalization being done based on market growth rates of market segments into which one or more patents have been categorized;
c. program instruction means for computing a normalized value for market share of the company in each market segment into which the patent is categorized, the normalization of the market share of the company in each market segment being done based on the market shares of all companies in the market segment; and
d. program instruction means for computing the EII value for the patent using at least one parameter from the set of parameters including the normalized value for market size of each market segment into which the patent is categorized, the normalized value for market growth rate of each market segment into which the patent is categorized, and the normalized value of the market share of the company in each market segment into which the patent is categorized.
